(19) United States
(12) Patent Application Publication
(10) Pub. No.: US 2010/0188712 A1
(43) Pub. Date: Jul. 29, 2010

(54) IMAGE PROCESSING APPARATUS AND IMAGE PROCESSING METHOD

(75) Inventors: Shinji Makishima, Tokyo (JP); Kazuhiro Ogura, Kanagawa-ken (JP); Akihiro Mizutani, Kanagawa-ken (JP); Toshihiro Ida, Tokyo (JP); Yusuke Hamada, Saitama-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/692,998

(22) Filed: Jan. 25, 2010

Related U.S. Application Data
(60) Provisional application No. 61/147,302, filed on Jan. 26, 2009.

(51) Int. Cl. G06K 15/02; G06K 9/00

(52) U.S. Cl. 358/3.28; 382/100; 358/1.14; 358/1.13; 358/1.15

(57) ABSTRACT

An image processing apparatus includes an image forming unit configured to form an image corresponding to input data on a sheet; and a CPU configured to determine, if the image is formed on the sheet, whether authority information concerning treatment of the image is included in the input data and cause. If the authority information is included, the image forming unit forms information concerning a license on the sheet. The information concerning the license is acquired by communication with a server that permits use of the input data based on the authority information.

### CROSS-REFERENCE TO RELATED APPLICATION

This application is based upon and claims the benefit of priority from: U.S. provisional application 61/147302, filed on Jan. 26, 2009, the entire contents of each of which are incorporated herein by reference.

### TECHNICAL FIELD

The present invention relates to an image processing apparatus and an image processing method capable of granting license information for permitting treatment of data to the data.

### BACKGROUND

Authority concerning treatment of an original document is in some case printed on the original document, which is paper, or added to electronic data of the original document. Consequently, when a user treats the original document, the user can understand, by visually recognizing the authority included in the original document (the paper or the electronic data), that the authority is granted to the original document. In other words, it is possible to inform, by adding the authority to the original document, the user that the treatment of the original document is limited.

However, when authority information is simply added to the original document (the paper or the electronic data), it is likely that the authority information is neglected in the treatment of the original document.

### SUMMARY

According to an aspect of the present invention, there is provided an image processing apparatus including: an image forming unit configured to form an image corresponding to input data on a sheet; and a CPU configured to determine, if the image is formed on the sheet, whether authority information concerning treatment of the image is included in the input data. The CPU cause, if the authority information is included, the image forming unit to form information concerning a license on the sheet. The information concerning the license is acquired by communication with a server that permits use of the input data based on the authority information.

According to another aspect of the present invention, there is provided a data processing apparatus including: an interface configured to communicate with a storage area for data; and a CPU configured to determine whether authority information concerning treatment of the data is included in the data. The CPU adds, if the authority information is included, information concerning a license to the data. The information concerning the license is acquired by communication with a server that permits use of the data based on the authority information.

According to still another aspect of the present invention, there is provided an image processing method including: determining, using a CPU, if an image corresponding to input data is formed on a sheet, whether authority information concerning treatment of the image is included in the input data; and forming, using an image forming unit, if the authority information is included, information concerning a license on the sheet together with the image. The information concerning the license is acquired by communication with a server that permits use of the input data based on the authority information.

### DESCRIPTION OF THE DRAWINGS

FIG. 1 is a diagram of the configuration of an image processing system according to a first embodiment of the present invention;

FIG. 2 is a diagram of the configuration of an MFP according to the first embodiment;

FIG. 3 is a flowchart for explaining processing for combining an issuance license with image data in the first embodiment;

FIG. 4 is a diagram of request data for the issuance license and content (an example) of the issuance license;

FIG. 5 is a flowchart for explaining processing for analyzing authority information in the first embodiment;

FIG. 6 is a diagram of an original document (an example) on which authority information is described;

FIG. 7 is a diagram of a relation between content of words included in authority information extracted from image data and authority information used for DRM;

FIG. 8 is a flowchart of processing for granting an issuance license to a print image in a second embodiment of the present invention;

FIG. 9 is a flowchart for explaining a processing for analyzing authority information in the second embodiment;

FIG. 10 is a diagram of content (an example) of a word management table in the second embodiment; and

FIG. 11 is a flowchart for explaining processing for combining an issuance license with file data in a third embodiment of the present invention.

### DETAILED DESCRIPTION

Embodiments of the present invention are explained below with reference to the accompanying drawings.

### First Embodiment

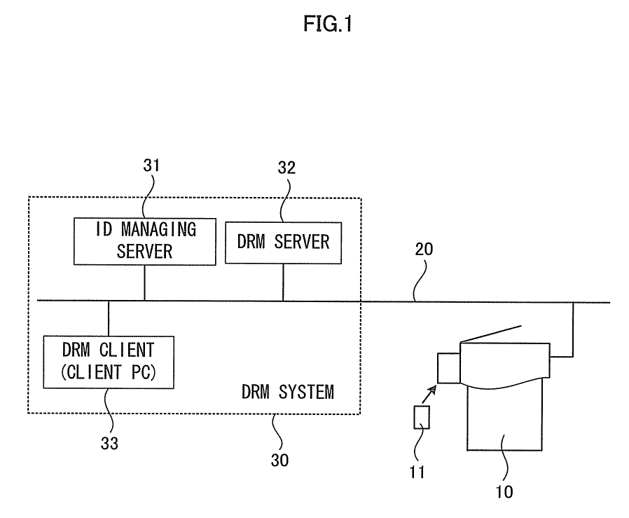

An image processing system according to a first embodiment of the present invention is explained below with reference to FIG. 1. FIG. 1 is a diagram of the overall configuration of the image processing system.

An MFP (Multi Function Peripheral) 10 is an image processing apparatus having plural functions such as a print function, a copy function, a facsimile function, and an image reading function. The MFP 10 has a user authentication function and can use, for example, an IC card 11 in order to authenticate a user. The MFP 10 is connected to a DRM (Digital Right Management) system 30 via a network 20.

The DRM system 30 includes a system configured to manage use authority for data. The DRM system 30 includes an ID managing server 31, a DRM server 32, and a DRM client (a client PC) 33. The ID managing server 31 manages user information of the MFP 10 and permits a registered user to use the MFP 10.

Specifically, the ID managing server 31 can permit the use of the MFP 10 if information managed by the ID managing server 31 and information of the IC card 11 coincide with each other. The DRM server 32 transmits an issuance license explained later or transmits a use license in response to a request from the outside. The DRM client 33 is a client PC configured to verify data combined with the issuance license and use the data according to authority information included in the issuance license.

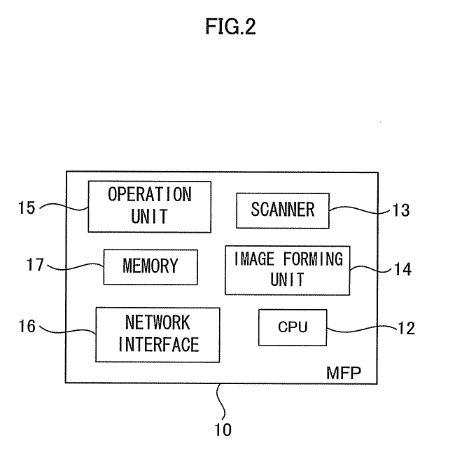

A hardware configuration in a part of the MFP 10 is shown in FIG. 2. The MFP 10 includes a CPU 12, a scanner 13, an image forming unit 14, an operation unit 15, a network interface 16, and a memory 17.

The CPU 12 controls the operations of the units included in the MFP 10. The scanner 13 reads an image of an original document such as a document or a photograph and generates image data. For example, the scanner 13 irradiates light on the original document, focuses reflected light of the original document on an image pickup element, and generates image data corresponding to the image of the original document on the basis of an output of the image pickup element.

The image forming unit 14 forms an image corresponding to input data on a sheet. As an image forming method by the image forming unit 14, for example, there is an electrophotographic method for forming a developer image on a photoconductive member and transferring the developer image onto a sheet and an ink jet method for ejecting ink to a sheet to form an image.

The operation unit 15 includes keys and buttons that are operated by a user who uses the MFP 10, and includes a display element such as an LED (Light-Emitting Diode) and an LCD (Liquid Crystal Display). The network interface 16 is connected to the network 20 and performs transmission and reception of data. The memory 17 includes a RAM (Random Access Memory), a ROM (Read Only Memory), or a hard disk (HDD). The memory 17 stores computer programs and data for processing explained later and stores image data.

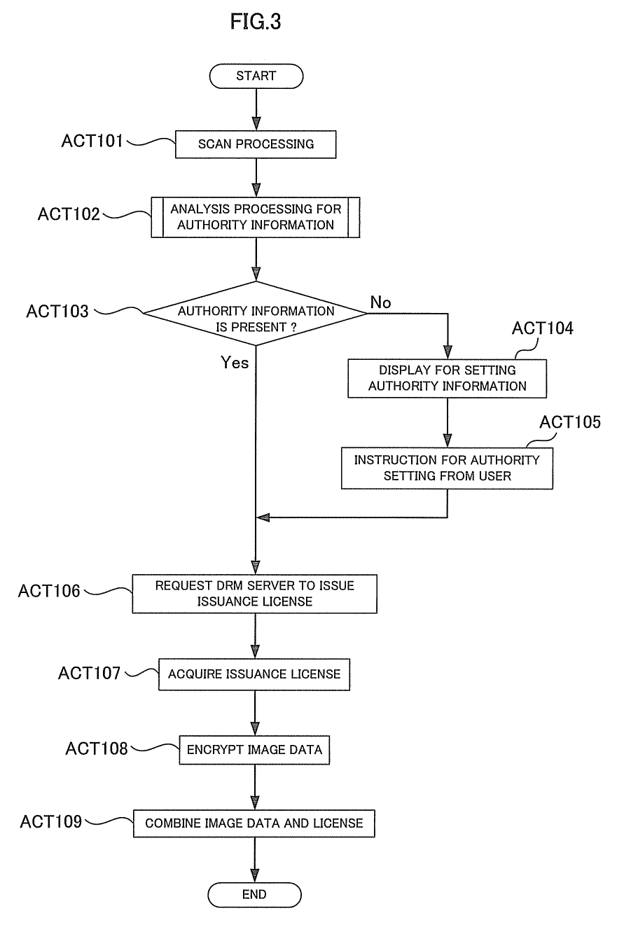

Processing in this embodiment is explained below with reference to FIG. 3. The processing shown in FIG. 3 is executed by the CPU 12 of the MFP 10.

When a user of the MFP 10 performs login processing using the IC card 11, the CPU 12 performs authentication of the user by communicating with the ID management server 31. When the user is authenticated, the user can cause the MFP 10 to operate. In the following explanation of this embodiment, the user causes the scanner 13 of the MFP 10 to operate.

When the user instructs scan operation by operating the operation unit 15, the CPU 12 causes the scanner 13 to operate and executes scan processing (ACT 101). Consequently, image data corresponding to an original document as a reading target is generated.

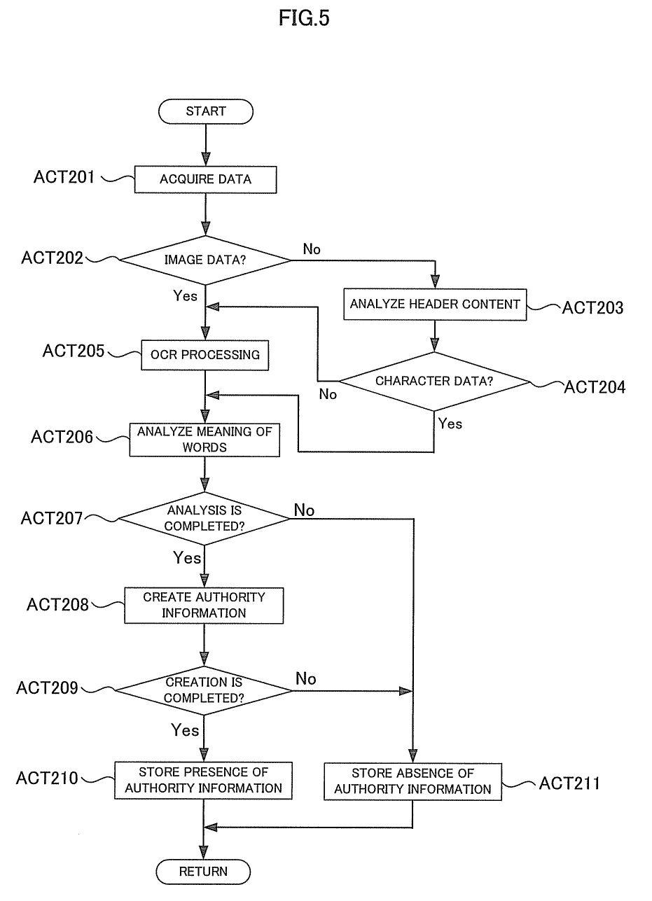

Subsequently, the CPU 12 performs analysis processing for authority information using the image data generated by the scanner 13 (ACT 102). The authority information is information concerning authority for treating an original document. In other words, the authority information is information for limiting treatment of the original document. In the analysis processing for authority information, it is determined whether authority information is included in the image data. Details of the analysis processing for authority information are explained later with reference to FIG. 5.

The CPU 12 determines whether authority information is present in the image data (ACT 103). When the CPU 12 determines that authority information is present (YES in ACT 103), the CPU 12 executes processing in ACT 106. When the CPU 12 determines that authority information is not present (NO in ACT 103), the CPU 12 executes processing in ACT 104.

When the CPU 12 determines that authority information is not present (NO in ACT 103), the CPU 12 sets a mode for setting authority information and performs display for setting authority information (ACT 104). Specifically, the CPU 12 causes a display of the operation unit 15 to display setting content of authority information. Consequently, the user can grant authority information to the image data generated by the scanner 13. When the user sets the authority information, the CPU 12 acquires information concerning the setting content (ACT 105).

In this embodiment, the mode for setting authority information is provided. However, the mode does not have to be provided. Specifically, if authority information is not present in the image data, the user can freely treat the image data obtained by the scan processing. Even in the mode for setting authority information, the CPU 12 can allow the user to select not to set authority information.

The CPU 12 requests the DRM server 32 to issue an issuance license (ACT 106). The CPU 12 acquires the issuance license from the DRM server 32 (ACT 107). The issuance license is, as explained later, data necessary for issuing a use license. The use license is, as explained later, data necessary for treating data combined with the issuance license. If the use license is acquired, it is possible to treat the data to which the issuance license is combined. Specifically, it is possible to view and print the data under predetermined authority information.

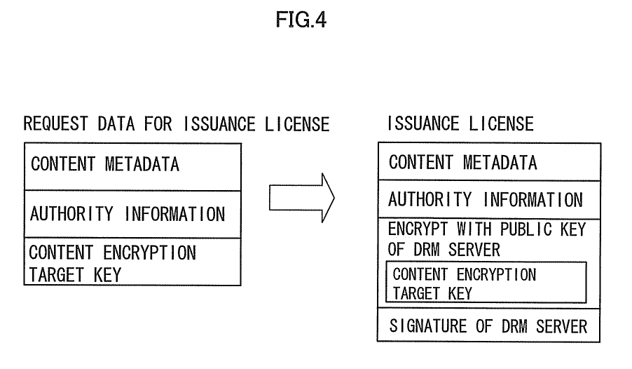

For example, the CPU 12 transmits request data for the issuance license shown in FIG. 4 to the DRM server 32. The DRM server 32 generates the issuance license shown in FIG. 4 and transmits the issuance license to the MFP 10.

The request data shown in FIG. 4 includes content metadata, authority information, and a content key. The content key is encrypted by using a public key acquired from the DRM server 32. As an encryption algorithm, it is possible to use publicly-known public encryption systems such as an RSA and a DSA.

When the DRM server 32 receives the request data shown in FIG. 4, the DRM server 32 decrypts, with a secret key of the DRM server 32, the content key encrypted by the public key. The DRM server 32 encrypts the decrypted content key using the public key of the DRM server 32. Subsequently, the DRM server 32 generates a signature using the secret key of the DRM server 32 with respect to the received authority information. A signature generation algorithm is not specifically limited. It is possible to apply various signature generation algorithms such as the RSA and DSA.

As shown in FIG. 4, the DRM server 32 can generate an issuance license using the authority information, the encrypted content key, and the generated signature. The generated issuance license is transmitted to the MFP 10 via the network 20.

The CPU 12 encrypts the image data (electronic data) obtained by the scan processing (ACT 108). The CPU 12 then combines the encrypted image data with the issuance license (ACT 109). The image data combined with the issuance license can be stored in the memory 17 of the MFP 10. The image data combined with the issuance license can also be stored in a document managing server (not shown) connected to the network 20.

The image data combined with the issuance license cannot be treated unless the use license is used. Specifically, when the image data combined with the issuance license is treated, the MFP 10 extracts the issuance license from the image data and transmits the issuance license to the DRM server 32 to thereby request the DRM server 32 to issue the use license. The MFP 10 receives, from the DRM server 32, the authority information and the content key that can be decrypted. Consequently, the MFP 10 can decrypt the encrypted image data using the content key and treat the decrypted image data in a range specified by the authority information.

The analysis processing for authority information (ACT 102) is explained with reference to FIG. 5. Processing shown in FIG. 5 is executed by the CPU 12.

The CPU 12 acquires an acquired data (ACT 201). The CPU 12 determines whether the acquired data is image data (ACT 202). When the CPU 12 determines that the acquired data is not image data, that is, the acquired data is PDL data (NO in ACT 202), the CPU 12 executes processing in ACT 203. When the CPU 12 determines that the acquired data is image data (YES in ACT 202), the CPU 12 executes processing in ACT 205.

In this embodiment, image data is acquired by the scan processing. However, even when data (image data) is input to the MFP 10, the processing shown in FIG. 5 can be performed.

When the CPU 12 determines that the acquired data is not image data (NO in ACT 202), the CPU 12 analyzes content described in a header using PDL data (ACT 203). The CPU 12 determines whether the content described in the header is character data (ACT 204). When the CPU 12 determines that the content of the header is the character data (YES in ACT 204), the CPU 12 proceeds to processing in ACT 206. When the CPU 12 determines that the content of the header is not the character data (NO in ACT 204), i.e., if the content of the header is the image data, the CPU 12 proceeds to the processing in ACT 205.

In the processing in ACT 203, the content of the header is analyzed. However, other areas can also be analyzed. For example, content of a footer can be analyzed. In general, authority information is often described in a header area or a footer area. Therefore, if content of the header area or the footer area is analyzed, the authority information can be acquired.

The CPU 12 applies OCR (Optical Character Recognition) processing to the image data to thereby analyze the content of the image data (ACT 205). The OCR processing is processing for converting image data obtained by the scan processing into a format (a sequence of character code) that can be edited by a computer. The CPU 12 analyzes meaning of words included in the image data using a result of the OCR processing (ACT 206).

The image data includes image data for directly displaying the words and image data for indirectly displaying the words. As the latter image data, for example, there is a two-dimensional code. When the two-dimensional code is used, it is necessary to perform processing for analyzing the two-dimensional code and specifying meaning corresponding to the two-dimensional code.

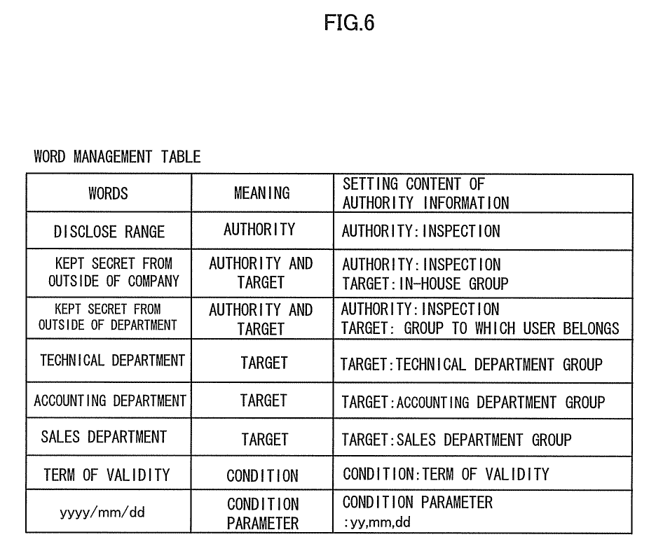

For the analysis of the meaning of the words, for example, as shown in FIG. 6, it is possible to use a management table in which words, meanings of the words, and setting contents of authority information are associated with one another. The management table can be stored in the memory 17 of the MFP 10.

The CPU 12 determines whether the analysis of the meaning of the words is completed (ACT 207). When the CPU 12 determines that the analysis of the meaning of the words is completed (YES in ACT 207), the CPU 12 creates authority information used in the DRM system 30 (ACT 208). The authority information created by the processing in ACT 208 is used in the processing in ACT 103 in FIG. 3.

The CPU 12 determines whether the authority information is successfully created (ACT 209). When the CPU 12 determines that the authority information is successfully created (YES in ACT 209), the CPU 12 regards that “authority information is present”, stores “the presence of authority information” (ACT 210), and ends the processing. When the CPU 12 determines that the authority information is not successfully created (NO in ACT 209), the CPU 12 regards that “authority information is absent”, stores “the absence of authority information” (ACT 211), and ends the processing.

When the CPU 12 determines in ACT 207 that the analysis of the meaning of the words is not completed (NO in ACT 207), the CPU 12 does not create authority information, i.e., regards that “authority information is absent”, stores “the absence of authority information” (ACT 211), and ends the processing.

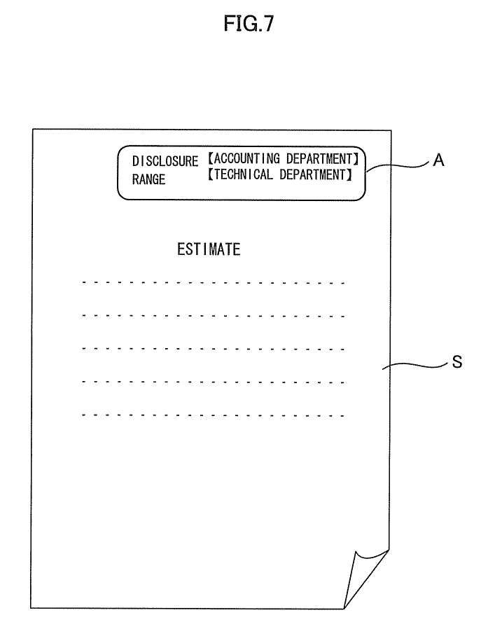

An original document S subjected to the scan processing shown in FIG. 7 is specifically explained. Authority information A is described in a header area of the original document S shown in FIG. 7. The authority information A indicates that a disclosure range of the original document S is limited to the Accounting Department and the Technical Department.

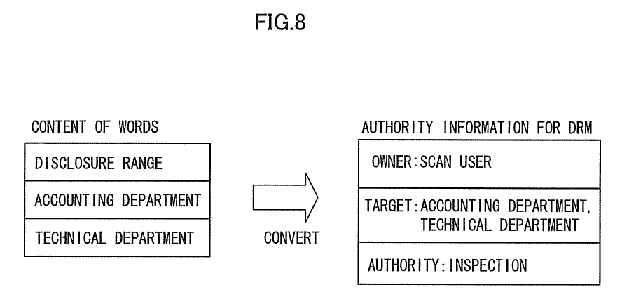

If the OCR processing is applied to the header area of the original document S shown in FIG. 7, the authority information A can be acquired. Content of words shown in FIG. 8 is obtained by analysis of words included in the authority information A. When the content of the words is obtained, authority information (an example) for DRM shown in FIG. 8 can be generated by using the management table shown in FIG. 6.

According to this embodiment, when image data is generated by the scan processing from an original document on which authority information is printed, an issuance license is combined with the image data. Therefore, it is possible to limit, on the basis of the authority information, treatment of the image data obtained by the scan processing.

### Second Embodiment

An image processing system according to a second embodiment of the present invention is explained below. Components having functions same as those explained in the first embodiment are denoted by the same reference numerals.

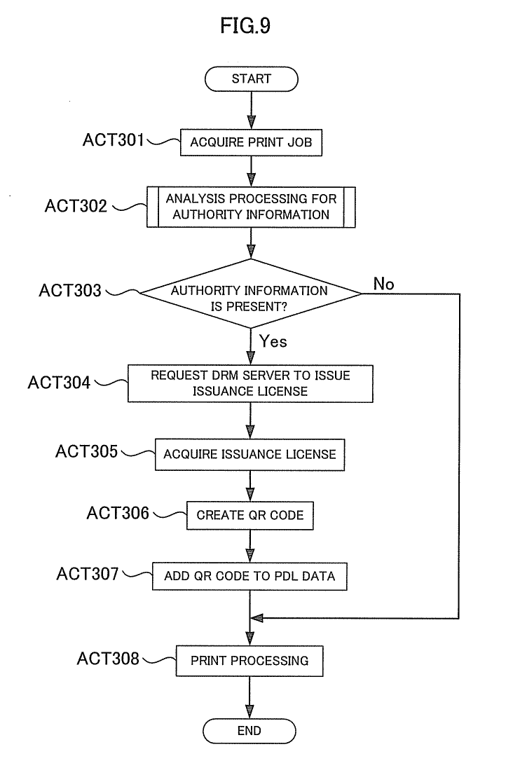

The operation of the image processing system according to this embodiment is explained with reference to FIG. 9.

When a user transmits print data (specifically, PDL data) to the MFP 10, the CPU 12 acquires a print job via the network interface 16 (ACT 301). The CPU 12 applies analysis processing for authority information to the print data (PDL data). As the analysis processing for authority information, for example, processing explained in the first embodiment (FIG. 5) is performed. Since the processing is the same as that in the first embodiment, detailed explanation of the processing is omitted. In this embodiment, in ACT 202 shown in FIG. 5, the print data is the PDL data. Therefore, the CPU 12 determines that the acquired data is not the image data (NO in ACT 202) and performs the processing in ACT 203.

The CPU 12 determines, on the basis of a result of the analysis processing for authority information, whether authority information is included in the print data (ACT 303). When authority information is not included in the print data (NO in ACT 303), the CPU 12 proceeds to the processing in ACT 308 and executes print processing corresponding to the print data.

On the other hand, when authority information is included in the print data (YES in ACT 303), the CPU 12 requests the DRM server 32 to issue an issuance license (ACT 304). The CPU 12 then acquires the issuance license from the DRM server 32 (ACT 305).

Subsequently, the CPU 12 creates a QR code corresponding to the acquired issuance license (ACT 306). A two-dimensional code other than the QR code can also be created. The issuance license and the QR code are associated with each other. When the QR code is analyzed, the issuance license can be specified.

The two-dimensional code can be recognized by observation from the outside. However, information that cannot be recognized by observation from the outside can be included in an image of the print data. For example, specific information can be included in the image of the print data by using an electronic watermark technique. The electronic watermark technique is a technique for embedding specific information with little influence on an image quality. When the electronic watermark technique is used, it is necessary to read out information indicating authority information from a print image.

When the QR code is created, the CPU 12 adds data indicating the QR code to the PDL data (ACT 307) and instructs the image forming unit 14 to execute print processing (ACT 308). Consequently, not only the image of the acquired print data but also the QR code is printed on a sheet obtained by the print processing.

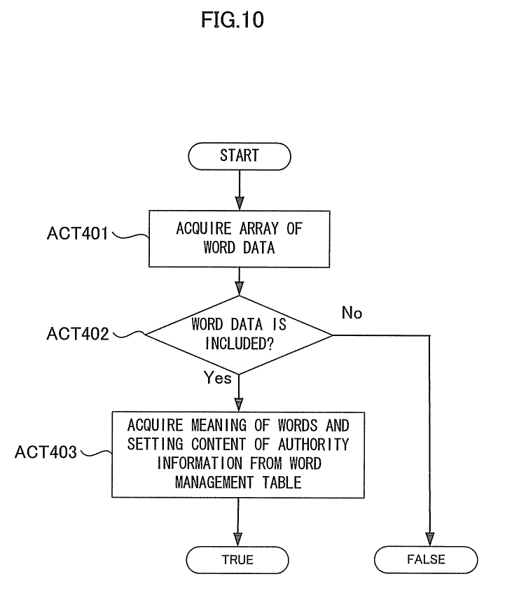

Another example of the analysis processing for authority information is explained below with reference to FIG. 10.

In FIG. 10, the CPU 12 acquires an array of word data using the received print data (PDL data) (ACT 401). For example, the CPU 12 determines whether the word data is included in a header area or a footer area (ACT 402). When the word data is included, the CPU 12 specifies meaning of words and setting content of authority information (ACT 403).

Specifically, the CPU 12 specifies meaning corresponding to the words included in the PDL data and the setting content of the authority information by using the management table shown in FIG. 6. When the word data is not included, the CPU 12 determines that authority information is not present and ends the processing.

According to this embodiment, when the user attempts to print data granted with authority information, not only an image as a print target but also information indicating an issuance license is printed. Consequently, when a printed sheet is treated, a use license has to be acquired. The treatment of the printed sheet can be limited on the basis of the authority information. For example, when the user attempts to scan the printed sheet using the MFP 10, the user has to receive the use license from the DRM server 32.

In this embodiment, the user transmits the print job to the MFP 10. However, this embodiment can also be applied when facsimile data is received.

### Third Embodiment

An image processing system according to a third embodiment of the present invention is explained below. Components having functions same as those explained in the first embodiment are denoted by the same reference numerals.

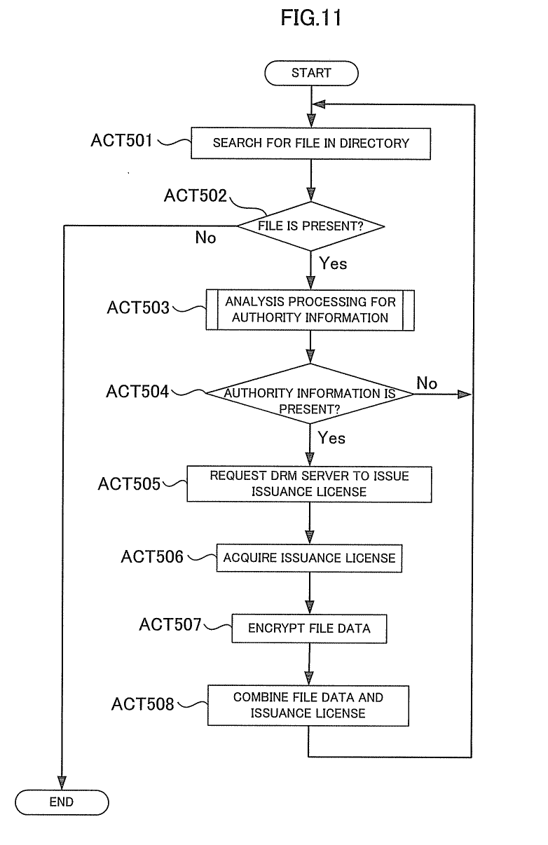

The operation of the image processing system according to this embodiment is explained with reference to FIG. 11. Processing shown in FIG. 11 is executed by the CPU 12 and can be performed, for example, periodically. Timing for starting the processing shown in FIG. 11 can be set as appropriate.

The CPU 12 searches for a file in a directory (ACT 501). When there are plural directories, the CPU 12 can searches for a file in a specific directory. The CPU 12 determines whether a file is present in the directory (ACT 502). When the CPU 12 determines that a file is not present in the directory (NO in ACT 502), the CPU 12 ends the processing.

When the CPU 12 determines that a file is present in the directory (YES in ACT 502), the CPU 12 applies the analysis processing for authority information to file data (ACT 503). The analysis processing for authority information can be performed in the same manner as that in the embodiment explained above (FIG. 5 or 10). The CPU 12 determines whether authority information is included in the file data (ACT 504). When the CPU 12 determines that authority information is not included in the file data (NO in ACT 504), the CPU 12 returns to the processing in ACT 501 and searches for a file in another directory.

When the CPU 12 determines that authority information is included in the file data (YES in ACT 504), the CPU 12 requests the DRM server 32 to issue an issuance license as explained in the first embodiment (ACT 505). The CPU 12 acquires the issuance license from the DRAM server 32 (ACT 506).

The CPU 12 encrypts the file data (ACT 507) and combines the issuance license with the encrypted file data (ACT 508). Consequently, the issuance license can be granted to the file present in the directory. When the file granted with the issuance license is treated, it is necessary to receive issuance of a use license.

In this embodiment, the CPU 12 determines whether authority information is granted to the file stored in the directory and, when authority information is granted, automatically combines the issuance license with the file. Consequently, it is possible to prevent presence of a file that is granted with authority information but treatment of which is not limited by the DRM system 30.

For example, when a user owns, as image data, an original document (paper) granted with authority information, it is possible to prevent, by granting an issuance license corresponding to the authority information to the image data, the image data from being treated on the outside of a range specified by the authority information.

A computer program for causing the CPU 12 to execute the processing explained in the embodiments can be stored in the memory 17 of the MFP 10 or a computer-readable recording medium. The recording medium only has to be a recording medium that can store the computer program and can be read by the computer. Examples of the recording medium include internal storage devices internally mounted in the computer such as a ROM and a RAM, portable storage media such as a CD-ROM, a flexible disk, a DVD disk, a magneto-optical disk, and an IC card, a database that stores a computer program, other computers and databases therefor, and a transmission medium on a line.

The present invention has been explained in detail with reference to the specific embodiments. However, it would be obvious to those skilled in the art that various modifications and alterations can be made without departing from the spirit and the scope of the present invention.

What is claimed is:

1. An image processing apparatus comprising:
an image forming unit configured to form an image corresponding to input data on a sheet; and
a CPU configured to determine, if the image is formed on the sheet, whether authority information concerning treatment of the image is included in the input data and cause, if the authority information is included, the image forming unit to form information concerning a license on the sheet, the information concerning a license being acquired by communication with a server that permits use of the input data based on the authority information.

2. The apparatus according to claim 1, wherein the CPU uses, as the information concerning the license, a two-dimensional code or information specified by an electronic watermark technique.

3. The apparatus according to claim 1, wherein the CPU determines whether the authority information is included in at least one of a header area and a footer area of the input data.

4. The apparatus according to claim 1, further comprising a scanner configured to read an image on an original document and convert the image into image data, wherein
the CPU determines whether authority information concerning treatment of the original document is included in the image data and add, if the authority information is included, information concerning a license to the image data, the information concerning the license being acquired by communication with a server that permits use of the original document based on the authority information.

5. The apparatus according to claim 4, wherein the CPU sets, if the authority information is not included in the image data, a mode for inputting the authority information.

6. The apparatus according to claim 4, wherein the CPU determines whether the authority information is included in at least one of a header area and a footer area of the image data.

7. A data processing apparatus comprising:
an interface configured to communicate with a storage area for data; and
a CPU configured to determine whether authority information concerning treatment of the data is included in the data and add, if the authority information is included, information concerning a license to the data, the information concerning the license being acquired by communication with a server that permits use of the data based on the authority information.

8. The apparatus according to claim 7, wherein the interface communicates with the storage area of the data via a network.

9. The apparatus according to claim 7, wherein the CPU periodically communicates with the storage area of the data.

10. The apparatus according to claim 7, wherein the CPU determines whether the authority information is included in at least one of a header area and a footer area of the image data.

11. An image processing method comprising:
determining, using a CPU, if an image corresponding to input data is formed on a sheet, whether authority information concerning treatment of the image is included in the input data; and
forming, using an image forming unit, if the authority information is included, information concerning a license on the sheet together with the image, the information concerning the license being acquired by communication with a server that permits use of the input data based on the authority information.

12. The method according to claim 11, wherein, as the information concerning the license, a two-dimensional code or information acquired by an electronic watermark technique is used.

13. The method according to claim 11, wherein it is determined whether the authority information is included in at least one of a header area and a footer area of the input data.

14. The method according to claim 11, further comprising,
reading an image on an original document using a scanner and converting the image into image data.

15. The method according to claim 14, wherein it is determined by the CPU whether authority information concerning treatment of the original document is included in the image data.

16. The method according to claim 15, further comprising,
adding, using the CPU, if the authority information is included in the image data, information concerning a license to the image data, the information concerning the license being acquired by communication with a server that permits use of the original document based on the authority information.

17. The method according to claim 16, further comprising,
setting, using the CPU, if the authority information is not included in the image data, a mode for inputting the authority information.

18. The method according to claim 16, wherein it is determined whether the authority information is included in at least one of a header area and a footer area of the image data.
